(19) United States
(12) Patent Application Publication
(10) Pub. No.: US 2009/0288089 A1
(43) Pub. Date: Nov. 19, 2009

(54) METHOD FOR PRIORITIZED EVENT PROCESSING IN AN EVENT DISPATCHING SYSTEM

(75) Inventors: Jonghyuk Choi, Old Tappan, NJ (US); Hubertus Franke, Cortlandt Manor, NY (US); Sang Seok Lim, Gwangsan-gu (KR)

Correspondence Address: MICHAEL BUCHENHORNER, P.A., 8540 SW 83 STREET, SUITE 100, MIAMI, FL, 33143, US

(73) Assignee: International Business Machines Corporation, Armonk, NY (US)

(21) Appl. No.: 12/122,357

(22) Filed: May 16, 2008

(51) Int. Cl. G06F 9/46

(52) U.S. Cl. 718/103

(57) ABSTRACT

A method for dynamically prioritizing event processing in an event dispatching system includes steps of: organizing input/output requests in a plurality of activity sets ordered from most active to least active, wherein a highest priority level is associated with the most active activity set and the lowest priority level is associated with the least active activity set; organizing event descriptors corresponding to the input/output requests into event descriptor sets; creating an event descriptor cache; duplicating the event descriptor of the input/output request found to be most active into the event descriptor cache; monitoring the event descriptor cache more frequently than the event descriptor set; and invoking an event dispatching routine from the event descriptor cache.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of information processing systems and more particularly relates to the field of methods for prioritized event processing in an event dispatching system.

### BACKGROUND OF THE INVENTION

Large scale servers serving a high volume of concurrent client requests are usually designed with sufficient concurrency in order to maintain high utilization of computing resources and to make the response time short and bounded. In order to achieve high concurrency in an effective manner, it is essential to provide an efficient multiplexing of the multiple execution threads, or tasks, of a given server instance. The multi-processes, the multi-threads, and the asynchronous input/output (I/O) engine are the representative architectures of realizing highly concurrent operations of multiple tasks. When a task needs to wait for client requests or for the completion of an I/O request, the processor can switch to another task that is ready for progress, instead of waiting for the event to complete in the original task. The execution of the original task will be resumed when the corresponding event is asynchronously delivered and dispatched in the future.

The event loop that processes the asynchronous events repeatedly forms the foundation of the server program architecture and has a large impact on the programming model and the performance of the server program. As a result, it is very important to efficiently implement the event loop in order to improve the throughput and reduce response time in the large scale server computers.

One of the most widely used event dispatching methods is to use a bit mask, each bit of which corresponds to an event descriptor associated with an I/O target such as a file and a network connection. In Unix-like operating systems, the file descriptor is used to represent generic I/O, and hence is used as an event descriptor for the corresponding I/O target or connection. The server program invokes an event dispatch routine with an interest set of event descriptors specified in the corresponding bit mask as an argument. The event dispatch routine then checks for any event arrival for the event descriptors in the interest set and then notifies the application of the occurrence of the events by returning the resulting set of event descriptors, again specified as a bit mask.

The select ( ) system routine specified in the POSIX 1003.1 standard is a representative of this method. Even though the bit mask representation is suitable for the case in which there are a large number of active connections, it is not suitable for the case in which only a small number of connections out of many are active because the overhead of setting, scanning, and copying a large bit mask can be a dominant part.

A variant of this approach is to use an array of event descriptors. The poll ( ) system routine specified in the POSIX 1003.1 standard is a representative of this method. While this method can be more effective than the bit mask-based method when only a small number of event descriptors out of many are included in the interest set, it tends to exhibit further performance degradation than the bit mask-based method when the size of the interest set increases and many connections are active because more data needs to be copied.

In addition to these two mechanisms which are specified in the POSIX standard, operating system specific methods have been proposed to improve the performance and scalability of event dispatching. One such method is to manage the interest set information persistently in a system. This can lead to reduced overhead of copying the potentially large interest set information per every invocation of the event dispatch routine. /dev/epoll of the open-source Linux operating system and /dev/poll of the Sun Solaris operating system are two such examples. /dev/epoll further reduces the overhead of queuing the task into the wait queues of the file data structures by providing a registration and invocation means of callback routines.

Another such example is to realize event dispatching by means of the real-time signal delivery as in POSIX.4 RT Signal of the Linux operating system. This method utilizes a specific real time signal to deliver an event through the signal queue of the waiting task. The signal is associated to the event descriptors through a control function such as fcntl ( ). Yet another method is the completion port of the Windows operating system in which an event is delivered to a waiting task as a packet to a specific port associated with a file handle.

Because these methods are operating system specific, the server programs have to be coded in a system specific manner and hence have poor portability. As a result, the standard methods of event dispatching specified in the POSIX standard, select ( ) and poll ( ), still remains as the predominant choice for high portability and compatibility. In addition, it is required to restructure the main event loop and the main data structure of the server programs in order to transform the server programs originally written in one of the said standard methods into the ones using the operating system specific methods. This restructuring is a highly complicated process and hence it may affect the reliability and manageability of the transformed coded. Furthermore, these system specific methods do not show the optimal performance in all cases. For instance, the performance of the said RT Signal method will be degraded when the method falls back to the said standard event dispatching methods once the real time signal queue overflows. This also overly complicates the design of the server program. It has also been observed that these non-standard methods can perform worse than the said standard methods when there are many I/O connections active at the same time.

Recently, an event dispatching mechanism which prioritizes I/O targets by performing event dispatching more frequently for an active descriptor set was proposed. Because of the temporal locality present in the requests arrived at the server, the prioritized processing can be effective in maintaining high server throughput without increasing the response time, even though only a small number of active event descriptors are being monitored frequently. The method in this prior art, however, only applies to the event dispatch methods which use the event descriptor list in an array form. It is not possible to realize the prioritized dispatching mechanism of the said prior art in the event dispatching mechanism using the bit mask. Moreover, the method in this prior art will result in a considerable amount of copying overhead when many descriptors are exchanged between sets frequently because the event descriptor array has to be compacted after such exchanges. More specifically, there was no known prior art of implementing the prioritized processing of I/O targets and connections in a POSIX standard compliant way.

In the event dispatching mechanisms where event descriptors are represented as a descriptor array, the methods of implementing the prioritized event dispatching scheme provided in the prior art are suboptimal. The prior art moves event descriptors from one set to another when changing the affiliation of the event descriptor upon an activity level change. This can lead to a significant performance penalty of compacting the entire descriptor array to remove holes especially when descriptors are moved frequently or when a large number of descriptors are moved.

### SUMMARY OF THE INVENTION

Briefly, according to an embodiment of the invention a method for dynamically prioritizing event processing in an event dispatching system includes steps of: organizing input/output requests in a plurality of activity sets ordered from most active to least active, wherein a highest priority level is associated with the most active activity set and the lowest priority level is associated with the least active activity set; organizing event descriptors corresponding to the input/output requests into event descriptor sets; creating an event descriptor cache; duplicating the event descriptor of the input/output request found to be most active into the event descriptor cache; monitoring the event descriptor cache more frequently than the event descriptor set; and invoking an event dispatching routine from the event descriptor cache.

According to another embodiment of the present invention, a computer program product embodied on a computer readable medium includes code for executing the method steps as outlined above.

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of the event prioritizing method according to an embodiment of the present invention;

FIG. 2 is a simplified illustration of event descriptor caching, according to an embodiment of the present invention;

FIG. 3 is a simplified illustration of backward mapping, according to an embodiment of the present invention;

FIG. 4 is an explicit event descriptor mapping method, according to an embodiment of the present invention;

FIG. 5 is a flowchart of a method for prioritized event dispatching, according to an embodiment of the present invention; and

FIG. 6 is a system for prioritized event dispatching, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

A solution to the above-stated need for a method of implementing a POSIX standard compliant prioritized processing of I/O targets and connections is presented. The present invention provides methods and apparatus of implementing a scalable event dispatching mechanism in a portable way that is transparent to an application. Further, it improves upon the select/poll scalability. The methods and apparatus, as will be described herein, make it possible to perform prioritized processing of I/O targets which are more active than others in the event dispatching mechanisms. The key technologies the present invention provide include the event descriptor duplication means and the backward mapping means for accomplishing effective descriptor mapping and application transparency.

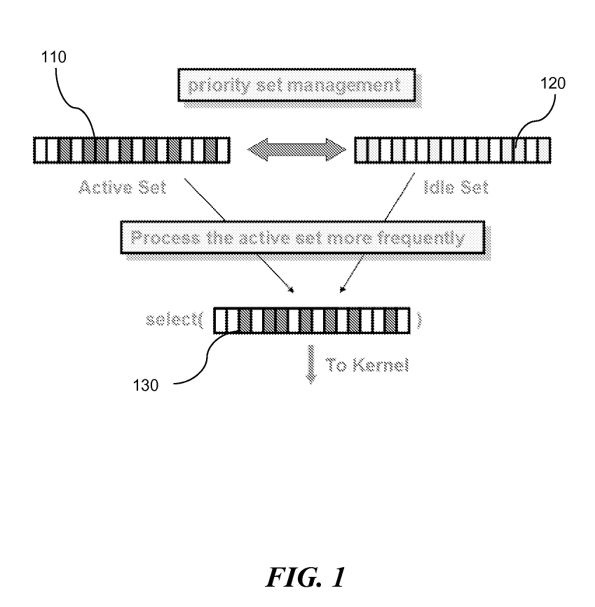

Referring now in specific detail to the drawings, and particularly FIG. 1, there is illustrated a simplified diagram showing the event prioritizing method according to an embodiment of the invention. In a prioritized I/O dispatching scheme, the event descriptors for I/O targets are managed in multiple sets 110, 120 according to the level of activity. If a connection is found to be active or is expected to become active soon, it can be moved to a more active set 110 in which the I/O targets are more frequently monitored for I/O activity 130 than in the original set 120. Conversely, if a connection is found to be idle, it can be moved to a less active set 120. Because of the temporal locality present in I/O channels and connections, the prioritized I/O dispatching scheme can improve the throughput of the server programs without degrading responsiveness.

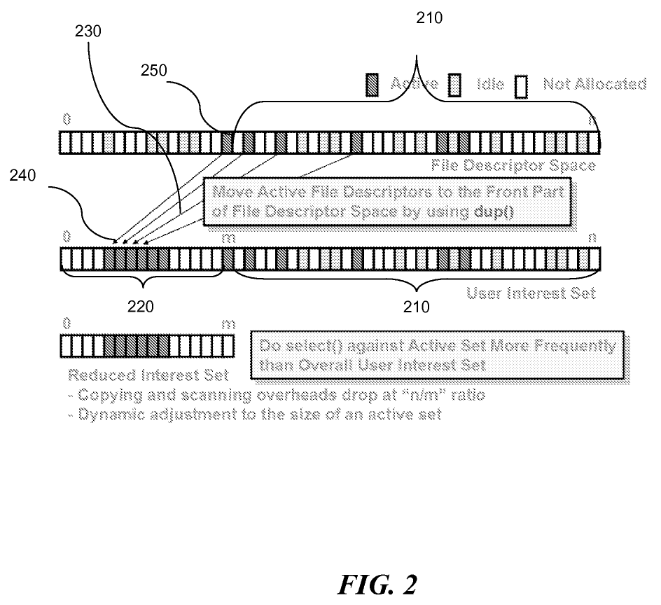

Referring now to FIG. 2 there is shown a simplified illustration of the event descriptor duplication means, according to an embodiment of the present invention. The event descriptor in an activity set 210 is duplicated to be included in another activity set 220. A duplicated event descriptor 240 is a replica of the original event descriptor 250, both of which point to the same I/O target data structure in the system. The same I/O target can be dispatched and accessed using multiple duplicated I/O descriptors. The event descriptor duplication means makes it possible to realize the prioritized event dispatching scheme in a very efficient manner.

The relative priority of the event is dynamically determined according to the activity levels of the event sources so that more active event sources will get higher event dispatching priority. In this sense, the methods and apparatus of the present invention can be considered as a caching mechanism for event dispatching. The event descriptor duplication method and apparatus implement the event descriptor cache while preserving the descriptor semantics specified in the POSIX standard. The backward mapping method and apparatus hide the presence of the event descriptor cache in order to achieve complete application transparency. In this manner, high performance and POSIX standard conformance are achieved.

This is the first and only way to realize the prioritized event dispatching scheme in a bit mask-based event dispatching scheme such as POSIX select ( ). This was previously considered to be impossible. In addition, this method enables a very efficient realization of the prioritized event dispatching scheme in a descriptor array based event dispatching scheme such as POSIX poll ( ). Duplication of event descriptors reduces the overhead of copying many array elements of the event descriptor array while moving the array descriptors from set to set.

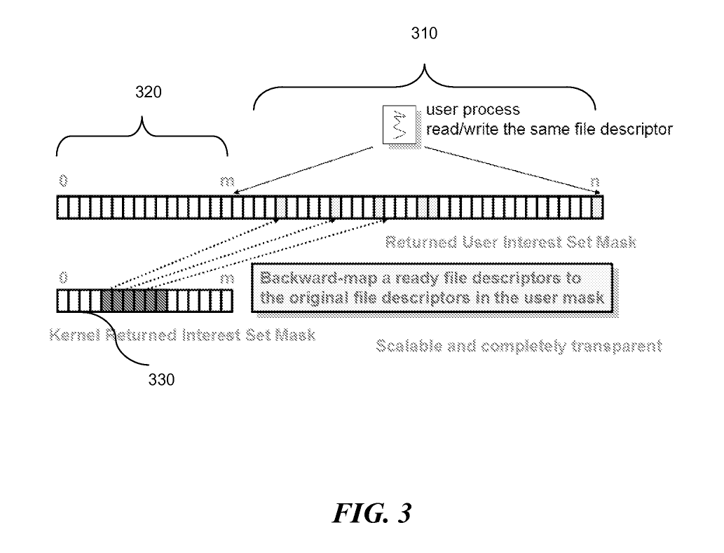

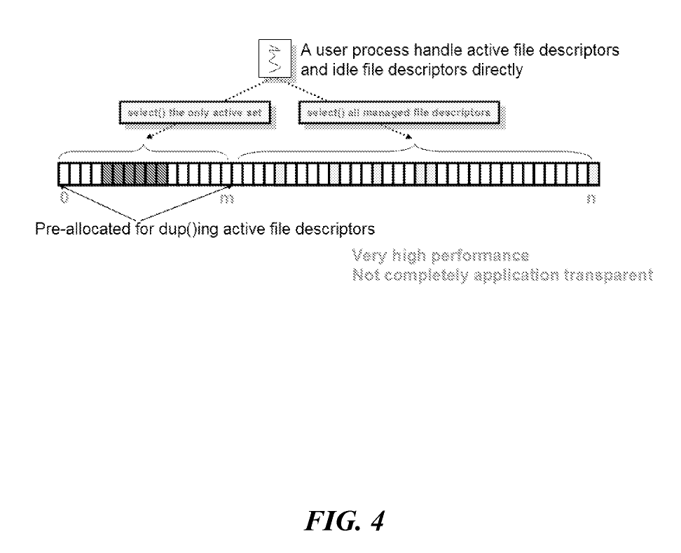

FIG. 3 illustrates the backward mapping means that maintains the portability and application transparency of the prioritized event dispatching scheme. Application programs are aware of the original event descriptors 310 only and it should be avoided to have the application programs be aware of the underlying prioritized sets of event descriptors 320. The backward mapping can be used in achieving this goal when an activity set containing the said duplicated event descriptors is used for event dispatching. Instead of notifying the application of the occurrence of events through the duplicated event descriptors, the event dispatching routine looks for the original event descriptors corresponding to the duplicated descriptors by looking up a backward mapping data structure and notifies of the event arrival through the original event descriptors 330. An alternative, less transparent partitioning is also possible as shown in FIG. 4 for higher performance operation.

The event descriptor duplication and the backward mapping means and apparatus enable a high performance and scalable realization of the prioritized event dispatching mechanisms in a portable and application transparent way. Because the resulting server applications are to be POSIX compliant, the proposed methods and apparatus can be easily used by arbitrary server application/middleware programs which use the POSIX compliant event dispatching mechanisms to boost their performance and scalability without needing to restructure their software and without needing to maintain multiple code paths, each of which is specifically optimized for a specific operating system.

The prioritized event dispatching schemes to which the present invention relates partition the I/O connections and the corresponding bit mask consisting of M bits (B0, B1 . . . BM−1) into N sets, S1, S1 . . . SN−1, where S0 is the set consisting of the most active I/O connections, SN−1 is the set consisting of the least active I/O connections, and the sets in between each consisting of I/O connections of activity level Ai such that Ai>Ai+1 holds. In the special case in which the I/O connections are partitioned into two sets, for instance, the first set S0 can be considered as the active set and the second set S1 can be considered as the idle set. The prioritized event dispatching schemes prioritize the event dispatching process by performing event dispatching for a set Si with a differentiated dispatching frequency utilizing the difference in the activity level Ai, i.e. with a dispatching frequency Pi such that Pi>Pi+1 holds.

In the prioritized event dispatching schemes an I/O connection can be upgraded to a more active set by moving the corresponding event descriptor to a more active set (from Sj to Si, where i<j) when the connection is found to be active or expected to be activated soon. Conversely, an I/O connection can be downgraded to a less active set by moving the corresponding event descriptor to a less active set (from Si to Sj, where i<j) when the connection is found to be idle or expected to become idle soon.

In the event dispatching mechanisms where event descriptors are represented as a bit mask, the event descriptor space represented by the descriptor bit mask is a per process resource and the server program should be able to continue to use the originally assigned event descriptor number. The present invention provides a method and apparatus which enables efficient mapping of event descriptors into different activity sets inside the event dispatch routine without needing to change the event descriptor numbers observed by the server program. More specifically, the present invention provides methods and apparatus of duplicating event descriptors as the means of the said event descriptor mapping.

In one embodiment of the present invention, the event descriptors are duplicated by invoking POSIX standard routines dup ( ) or dup2 ( ) 230. A duplicated event descriptor refers to the same I/O data structure inside the operating systems as the original event descriptor, even though they are distinct.

The methods and apparatus presented in the present invention partition the entire event descriptor space into N distinct segments. The first segment corresponds to S0 which is the set consisting of the most active I/O connections and the last segment corresponds to SN−1 which is the set consisting of the least active I/O connections. An I/O connection is assigned a home event descriptor in SN−1. If the I/O connection is found to be active, then the home event descriptor is duplicated into Si (i<N−1). The duplicated event descriptors in the more active event sets, Si (i<N−1), can be used in the same way as the original home event descriptors.

When an active set Si is monitored for event dispatching, the segment of the bit mask which corresponds to the set Si is included in the interest descriptor set of the event dispatch routine invocation. It is one of the intentions of the present invention to exclude the event descriptors of the activity sets Sj which are less active than the activity set Si (i<j) that is currently being monitored for I/O activity in order to keep the overhead of event dispatching small.

The descriptor duplication means and apparatus provided in the present invention solves the problem of having to remove holes in an descriptor array. If an event descriptor can be duplicated from a less active set to a more active set, it is not required to remove the original event descriptor from the less active set. An activity set Si with the original event descriptors still intact can be used to perform event dispatching for all event descriptors which have the activity level equal to or higher than Ai. This property can be utilized for an activity set with a large size to reduce the copying overhead. Hence the descriptor duplication means provided by the present invention can be used to improve the performance and scalability of the descriptor array based event dispatching mechanism as well.

In one embodiment of the present invention, all event descriptors in a bit mask segment assigned to an activity set may not be used when the actual size of the activity set is smaller than the originally assigned size. When the actual set size is smaller than the size of the statically assigned bit mask segment, the interest bit mask is set only for those event descriptors that are actually used in the activity set. In the segment corresponding to the least active set inside the bit mask, it is possible not to include the part of the bit mask in the segment which are not used in the activity set. The size of the actual activity set is less than or equal to the size of the originally assigned bit mask segment.

The present invention also provides methods and apparatus for dynamic control of the size of each activity set by monitoring the characteristic indices of the system and the services it provides such as throughput, response time, and the effectiveness measure of the prioritized event dispatching scheme.

The present invention also provides a means of replacement for the case in which the current activity set is full of event descriptors. A victim descriptor is selected and evicted into a less active set in order to make a room for the newly duplicated event descriptor. Examples of such replacement algorithms include LRU, LFU, and more adaptive algorithms. The least active event set, SN−1, hosts home bit mask locations for all event descriptors. The home event descriptors in this set cannot be displaced because the server program should be able to make continued use of these descriptors.

In order to perform event dispatching for the descriptors duplicated in one of the active sets (Si, i<N−1) in a way that is transparent to the server program, the present invention also provides a backward mapping means. A mapping between the duplicated event descriptors and the original home event descriptors are maintained in order to map the duplicated descriptors to those which are known to the server programs. When the event dispatch routine provided in the present invention returns, the bit mask locations for the original event descriptors are set so as to realize the prioritized event dispatching in an application transparent and standard conforming manner. The present invention can also be used without the backward mapping means for improved performance in sacrifice of the complete application transparency. In this case, the server program should be aware of the presence of the activity sets and need to handle the duplicated event descriptors directly.

In one embodiment of the present invention, the bit masks for event descriptors are scanned in a clustered manner in order to reduce the linear scanning overhead of the bit mask locations. The bit mask can be hierarchically scanned by checking a cluster of bits such as single/double/quad words and as even bigger data types. If there is an activity in such a cluster, individual bits of the cluster need to be scanned further. This can be effective especially when only a small number of I/O targets remain active at any given time.

In one embodiment of the present invention, a means of determining whether to activate a given activity set, Si, and a means of activating/deactivating the activity set when the activity set is turned out to be effective/ineffective, respectively.

One embodiment of the present invention implements a differentiated service according to various attributes of I/O connections and to the predefined policy such as event history and service level agreement for the accounts to which the I/O connections belong.

One such means implements prioritization through an event descriptor aging apparatus assigned to each priority. They attribute each connection with an age it stayed in the current priority set. The age of a connection keep increasing with time unless it is replenished upon arrival of a new event at the connection. The most aged connections in a priority set get demoted to the next low priority set should more room be made in the set for less aged connections. Upon arrival of a new event, a connection can be promoted to a higher priority set according to the event activity level and history of the connection. The priority set promotion and demotion criteria can be weighted by various criteria to provide differentiated service to different class of client connections and events.

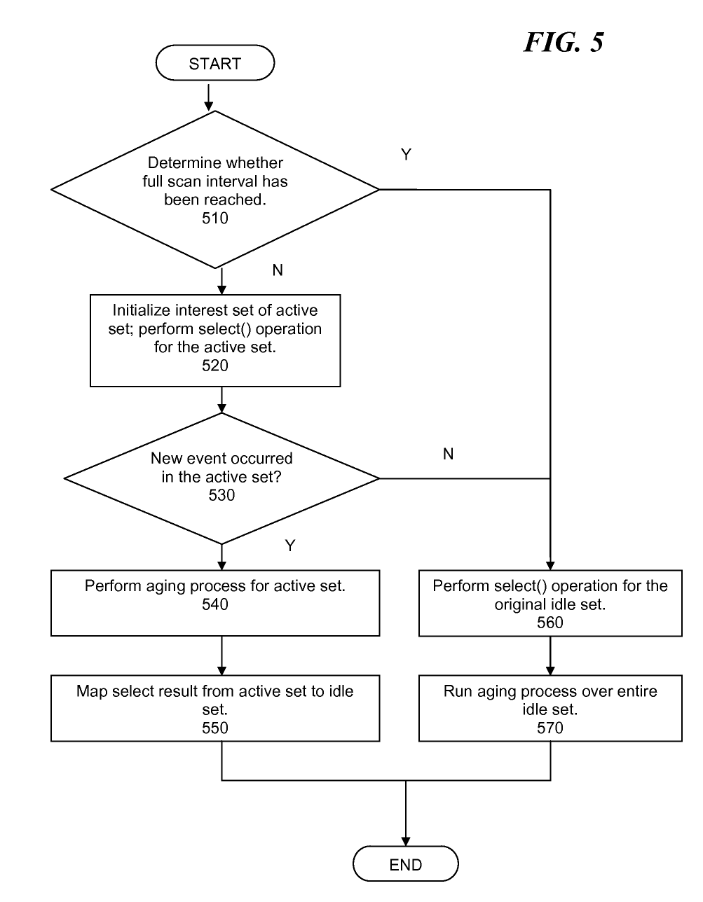

FIG. 5 illustrates one embodiment of the prioritized event dispatching method of the present invention provided for the two priority set case. In step 510, it determines whether the full scan interval is reached. The full scan interval is a time period in which every event descriptor in the idle set should be scanned and examined for event occurrence at least once. The inverse of the full scan interval can be considered as the worst case event dispatching rate for the event descriptors in the idle set. When the full scan interval of the idle set is reached, it performs select( ) operations for the original idle set (step 560) and runs the aging process over the entire idle set (step 570).

If the full scan interval is not reached, it performs select( ) operation only for the active set in step 520 after initializing the interest set of the active set from the idle set in step 510. Between the two consecutive invocations of the event dispatching method in FIG. 5, the interest set can be changed by the user program. Because the user program specifies the interest set to the event descriptors in the idle set, but not in the active set, the interest set of the active set should be updated in accordance with the new interest set in the idle set. It then checks whether a new event occurred in the I/O connections cached in the active set (step 530).

If no such event occurred, it will go to step 560 to perform a full scan over the idle set. If new events are returned in step 530, it performs the aging process only for the active set (step 540) and performs mapping of the select( ) result from the active set to the idle set (step 550). The aging process is a known technique of implementing an LRU cache replacement scheme in software. Even though this method is illustrated for the two priority level case, it can be easily generalized without loss of generality for the more priority level case.

In one embodiment of the present invention, a priority level is associated with a time period during which it is guaranteed that the I/O connections in that priority level receive one scanning for the new actives at least once per the associated time period. For example, again with the two priority level case, if the time period is set to 200 ms for the idle priority set, all the I/O connections are guaranteed to be scanned for new events at least once per 200 ms.

The methods provided by the present invention also solve the drawback of implementing limited prioritized event processing schemes for poll( ). The prior art moves event descriptors from one set to another when changing the affiliation of the event descriptor upon promotion or demotion. This can lead to a significant performance penalty of pruning the descriptor arrays to remove holes, especially when descriptors are moved frequently or when a large number of descriptors are moved. In the descriptor duplication means of the present invention, it is not required to remove the original event descriptor from the lower priority set when an event descriptor is duplicated upon promotion. The low priority set Sᵢ can use all those event descriptors promoted to Sⱼ (i>j) when it performs event dispatching for all event descriptors which have the priority level equal to or higher than Pᵢ. This property can be utilized for a priority set with a large size to reduce the copying overhead. Hence the descriptor duplication means provided by the present invention can be used to improve the performance and scalability of the descriptor array based event dispatching mechanism such as poll( ) as well.

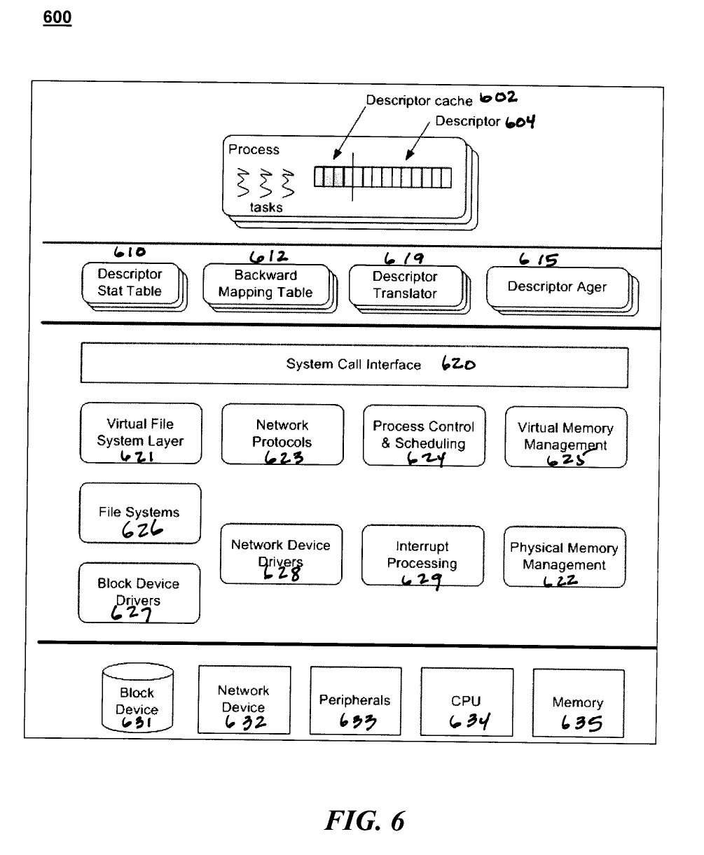

Referring to FIG. 6, there is shown a block diagram of an information handling system 600 consistent with an embodiment of the present invention. For purposes of this invention, computer system 600 may represent any type of computer, information processing system or other programmable electronic device, including a client computer, a server computer, a portable computer, an embedded controller, a personal digital assistant, and so on. The computer system 600 may be a stand-alone device or networked into a larger system.

The system 600 could include several per-process data storage and control units that are needed for implementing the prioritized event processing method. Each process has an event descriptor space divided into the first event descriptor cache space 602 which is used for implementing the active descriptor set and the second event descriptor space 604 which is left for the conventional event descriptors accessed by the user program.

In order to provide the full transparency in terms of the assignment of the descriptor numbers starting from zero, each process is equipped with a descriptor translator unit 619 that provides translation between the descriptor ID the user program uses and that the system calls observe. Each process is also equipped with a descriptor aging unit 615 that performs the replacement of unused cache entries according to an LRU policy. The descriptor aging unit 615 utilizes information stored in the per-process descriptor stat table 610 to determine which cached descriptor entries to evict from the descriptor cache 602. The per-process backward mapping table 612 is utilized to identify the corresponding event descriptors in the idle descriptor set from the results of the system calls specified on the cached descriptors.

Further, the system 600 may include a system call interface 620 and system components such as a virtual file system layer 621, network protocols 623, process control and scheduling 624, virtual memory management 625, file system 626, block device drivers 627, network device drivers 628, interrupt processing 629, and physical memory management 622. These components may be part of standard computer components such as a block device 631, network device 632, peripherals 633, a CPU 634, and memory 635.

What has been shown and discussed is a highly-simplified depiction of a programmable computer apparatus. Those skilled in the art will appreciate that a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include ROMs, DVD-ROMs, and transmission-type media, such as digital and analog communication links, wired or wireless communications links using transmission forms, such as, for example, radio frequency and light wave transmissions. The signal bearing media make take the form of coded formats that are decoded for use in a particular data processing system.

Therefore, while there has been described what is presently considered to be the preferred embodiment, it will understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

We claim:

1. A method for dynamically prioritizing event processing in an event dispatching system, the method comprising steps of:
organizing input/output requests into a plurality of activity sets ordered from most active to least active, wherein a highest priority level is associated with the most active activity set and the lowest priority level is associated with the least active activity set;
organizing event descriptors corresponding to the input/output requests into event descriptor sets comprising distinct segments from most active to least active;
creating an event descriptor cache;
duplicating the event descriptor of the input/output request found to be most active into the event descriptor cache;
monitoring the event descriptor cache more frequently than the event descriptor set; and
invoking an event dispatching routine from the event descriptor cache.

2. The method of claim 1 further comprising a step of:
upgrading an input/output request to a more active set by moving the corresponding event descriptor to a more active set when the request is found to be active or expected to be activated soon.

3. The method of claim 2 further comprising a step of:
downgrading an input/output request to a less active set by moving the corresponding event descriptor to a less active set when the request is found to be less active.

4. The method of claim 1 wherein the event dispatching system is a bit mask-based system.

5. The method of claim 4 wherein the event dispatching system is POSIX select ( ).

6. The method of claim 1 wherein the event dispatching system is a descriptor array based system.

7. The method of claim 6 wherein the event dispatching system is POSIX poll ( ).

8. The method of claim 1 wherein the input/output requests are organized into only two sets, an active set and an idle set.

9. The method of claim 1 wherein duplicating the event descriptor comprises invoking POSIX standard routines.

10. The method of claim 1 further comprising a step of:
excluding event descriptors of activity sets with a lower activity level than the activity set that is currently being monitored for input/output activity

11. The method of claim 1 further comprising a step of:
performing backward descriptor mapping for mapping duplicate event descriptors to event descriptors; and
notifying an application using the original event descriptor set mapped from the duplicate event descriptors.

12. The method of claim 1 further comprising a step of:
translating the event descriptors of the input/output requests such that the event descriptors visible to a user program remain unchanged.

13. The method of claim 1 further comprising a step of:
scanning the event descriptor cache for new active input/output requests.

14. The method of claim 12 further comprising steps of:
associating the priority level with a time period; and
scanning that priority level at least once per the associated time period.

15. A computer program product tangibly embodied on a computer readable medium and comprising code that, when executed, causes a computer to perform steps of:
organizing input/output requests into a plurality of activity sets ordered from most active to least active;
organizing event descriptors corresponding to the input/output requests into event descriptor sets comprising distinct segments from most active to least active;
creating an event descriptor cache;
duplicating the event descriptor of the input/output request found to be active into the event descriptor cache;
monitoring the event descriptor cache more frequently than the event descriptor set; and
invoking an event dispatching routine from the event descriptor cache.

16. An information processing system comprising:
a per-process event descriptor space comprising a first event descriptor cache space used for implementing an active descriptor set and a second event descriptor cache space for conventional event descriptors accessed by a user program;
a descriptor translator unit that provides translation between an event descriptor used by a user program and an event descriptor that system calls observe;
a per-process descriptor translator unit that provides translation between descriptors the user program uses and descriptors that the system calls observe;
a per-process descriptor aging unit that performs replacement of unused cache entries;
a per-process descriptor stat table comprising cached descriptor entries;
a per-process backward mapping table that identifies corresponding event descriptors in an idle descriptor set from results of system calls specified on the cached descriptors;
a system call interface; and
system components necessary to run the information processing system.
